(19) United States
(12) Patent Application Publication
(10) Pub. No.: US 2019/0313664 A1
(43) Pub. Date: Oct. 17, 2019

(54) AUTOMATED SEMI-FROZEN BEVERAGE MACHINE, METHOD OF USE, AND METHOD OF MANUFACTURE

(71) Applicants: Harry Earl Haas, Overland Park, KS (US); Sandra K. Haas, Overland Park, KS (US)

(72) Inventors: Harry Earl Haas, Overland Park, KS (US); Sandra K. Haas, Overland Park, KS (US)

(21) Appl. No.: 16/382,088

(22) Filed: Apr. 11, 2019

Related U.S. Application Data
(60) Provisional application No. 62/656,110, filed on Apr. 11, 2018.

(51) Int. Cl. A23G 9/04; A23G 9/08

(52) U.S. Cl. CPC A23G 9/045; F25C 1/147; A23G 9/08

(57) ABSTRACT

An automated semi-frozen beverage machine, method of use, and method of manufacturing an evaporator cylinder. The machine includes a bowl system including one or more bowls, each having a mixing chamber, a dispensing assembly, and a lid assembly. The beverage machine includes a refrigeration system having a compressor and a condenser, which are mounted in a base cabinet, and an evaporator cylinder mounted within the bowl mixing chamber. The evaporator cylinder is made up of a steel cylinder with copper tubing coiled within. The copper coil within the evaporator cylinder includes flattened outer edges such that the outer edges of the copper tubing make contact with substantially the entire inner surface area of the steel cylinder, increasing heat transfer efficiency. A mixing system includes an auger rotatably mounted in the bowl mixing chamber around the evaporator cylinder for mixing beverages in the bowl.

### CROSS-REFERENCE TO RELATED APPLICATION

This application claims priority in U.S. Provisional Patent Application No. 62/656,110, filed Apr. 11, 2018, which is incorporated herein by reference.

### BACKGROUND OF THE INVENTION

### 1. Field of the Invention

The present invention relates generally to beverage machines, and more particularly to an automated machine for making semi-frozen beverages, method of use, and production method.

### 2. Description of the Related Art

Semi-frozen beverages are very popular to consumers, and a wide variety of flavors of semi-frozen beverages are available at commercial establishments. For instance, nonalcoholic, semi-frozen beverages are commonly made from fruit juices, flavorings, sweeteners, and other ingredients, which are typically blended, mixed, and/or stirred to produce slush-like consistencies. An advantage of such beverages is that they can be served and consumed without adding ice. Therefore, semi-frozen beverages tend to be popular with commercial establishments such as convenience stores and restaurants, which can quickly and efficiently dispense them in significant quantities.

Alcoholic semi-frozen beverages are also very popular to consumers, such as frozen margaritas and daiquiris. Little or no skill or training is necessary to operate automated equipment for producing semi-frozen beverages. Moreover, significant commercial quantities can be produced in volume, as opposed to mixing drinks individually. Sales of significant commercial quantities can thus be efficiently achieved. Accordingly, semi-frozen beverages tend to be popular with operators and patrons of commercial drinking establishments.

Semi-frozen beverages are also often enjoyed in noncommercial settings, including at private residences. For instance, semi-frozen beverages are commonly served at parties, family gatherings, and other events with family and friends.

An issue with currently available semi-frozen beverage machines, such as the beverage machine disclosed in U.S. Pat. No. 7,603,870 granted to Mavridis et al., which patent is incorporated by reference herein in its entirety, is the period of wait time required between filling the beverage machine with a beverage in liquid form and the beverage reaching a desired, ready-to-drink, semi-frozen state. Moreover, some currently available semi-frozen beverage machines do not reliably freeze beverages to the desired semi-frozen consistency or freeze beverages more frozen than desired.

What is desired is a quick, efficient, reliable semi-frozen beverage machine. Heretofore there has not been available an automated machine for making semi-frozen beverages and process of manufacturing a semi-frozen beverage machine with the advantages and features of the present invention.

### SUMMARY OF THE INVENTION

In the practice of an aspect of the present invention, a machine is provided for making and dispensing semi-frozen beverages. The machine includes a bowl system, which can include one or more bowls, each having a mixing chamber and a lid assembly. A dispensing assembly is mounted on each bowl and includes a valve, which can be opened and closed by an operator to dispense contents of the bowl. A mixing system includes an auger rotatably mounted in the bowl mixing chamber around an evaporator cylinder. A gear-driven motor assembly is connected to the auger for rotation of the auger. A refrigeration system includes a compressor and a condenser, which are mounted in a base cabinet, and the evaporator cylinder mounted within the bowl mixing chamber. In an embodiment, the evaporator cylinder is made up of a hollow steel cylinder with copper tubing tightly coiled within the steel cylinder. The copper tube coil within the evaporator cylinder of the present invention includes flattened outer edges such that the outer edges of the copper tubing make contact with substantially the entire inner surface area of the steel cylinder. The evaporator cylinder receives refrigerant from the compressor and lowers the temperature of the bowl contents to a desired semi-frozen, slush-like consistency for mixing and discharge by the auger and the dispensing valve. The dispensing valve can be secured by an optional locking mechanism.

In the practice of another aspect of the present invention, a process for manufacturing an evaporation cylinder for a machine for making and dispensing semi-frozen beverages is provided. The process includes coiling copper tubing within a stainless steel cylinder and then applying high pressure to the coil, resulting in expansion of the copper tubing such that the outer edge of the copper tubing flattens up against the inside surface of the stainless steel cylinder. The resulting evaporator cylinder is an effective refrigeration system for a semi-frozen beverage machine. The refrigeration system according to the present invention accommodates quick and efficient refrigeration of a beverage mix to a desired semi-frozen consistency.

### BRIEF DESCRIPTION OF THE DRAWINGS

The drawings constitute a part of this specification and include exemplary embodiments of the present invention illustrating various objects and features thereof.

FIG. 1 shows an upper, front, right, perspective view of an automated semi-frozen beverage machine embodying the present invention.

FIG. 2 shows an upper, front, right, fragmentary, perspective view of a bowl system of the automated semi-frozen beverage machine with a cutout of a portion of a right side of the bowl to display the auger assembly and evaporation cylinder within.

FIG. 3 is a front, elevational view of the bowl system of the automated semi-frozen beverage machine.

FIG. 4 is a back, elevational view of the automated semi-frozen beverage machine.

FIG. 5 is an upper, back, fragmentary, perspective view showing the auger assembly, gear driven motor, and gears of the semi-frozen beverage machine.

FIG. 6 is an enlarged, cross-sectional view of connections of the drive shaft, auger back bearing, and an upper gear.

FIG. 7 is an enlarged, cross-sectional view of the drive shaft coupling receiver.

FIG. 8 is an enlarged, upper, back, perspective view of a back end portion of the drive shaft.

FIG. 9 shows, a side, fragmentary, elevational view of the semi-frozen beverage machine, without the auger assembly and showing an internal portion of the evaporator cylinder and the inlet and outlet ports.

FIG. 10 shows an upper, front, fragmentary, perspective view of the evaporator cylinder of the semi-frozen beverage machine showing the inner coiled tubing with expanded, flattened outer edges.

FIGS. 11a and 11b show enlarged, back, fragmentary, elevational views of gears of the auger assembly, within associated gearboxes, and the product consistency control mechanism.

FIG. 12 shows an enlarged, front, perspective view of a lid assembly half.

FIG. 13 shows a front, elevational view of a dual-plate locking mechanism.

FIG. 14 shows a perspective view of a retainer of the dual-plate locking system positioned in a dispensing tube, which is shown in dashed lines.

FIG. 15 shows a front, elevational, exploded view showing a single-plate locking mechanism.

FIG. 16 shows a front, elevational, assembled view of the single-plate locking mechanism.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right, and left refer to the invention as orientated in the view being referred to. The words “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

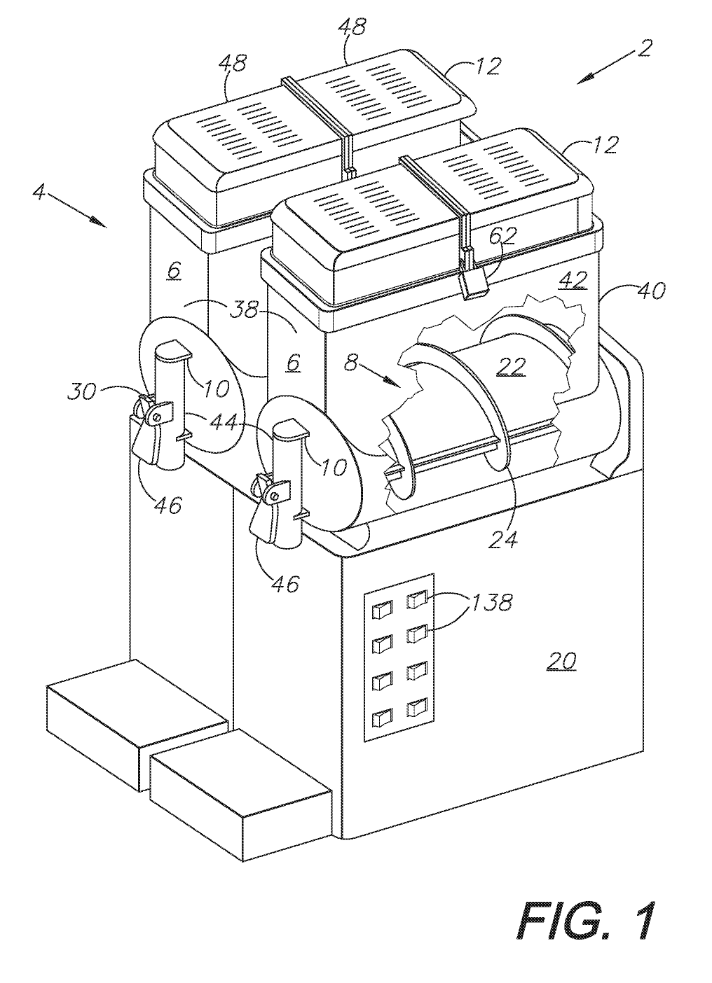

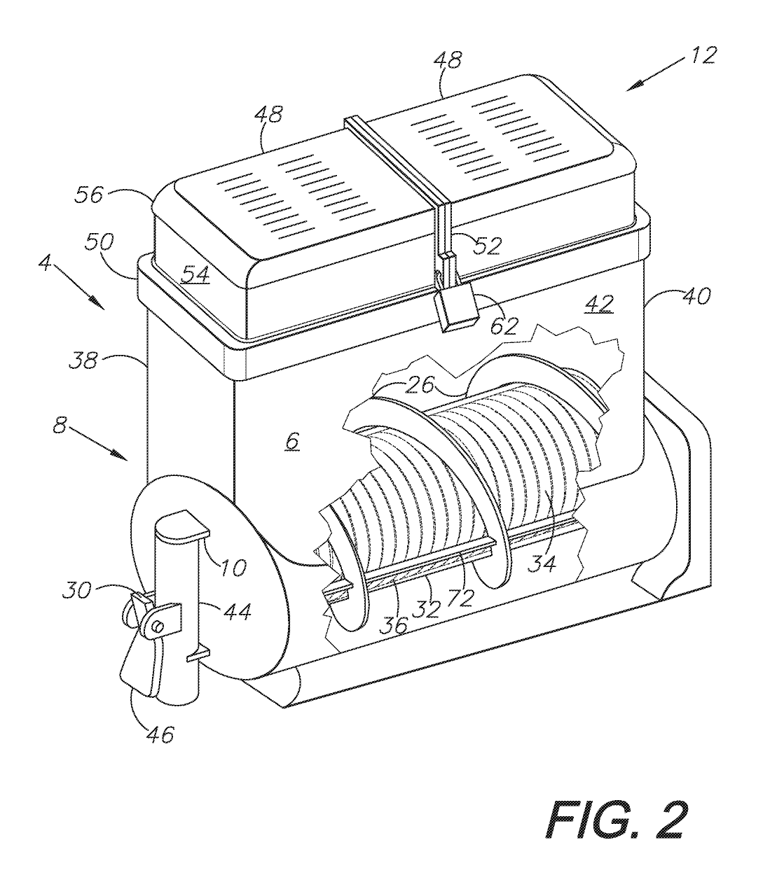

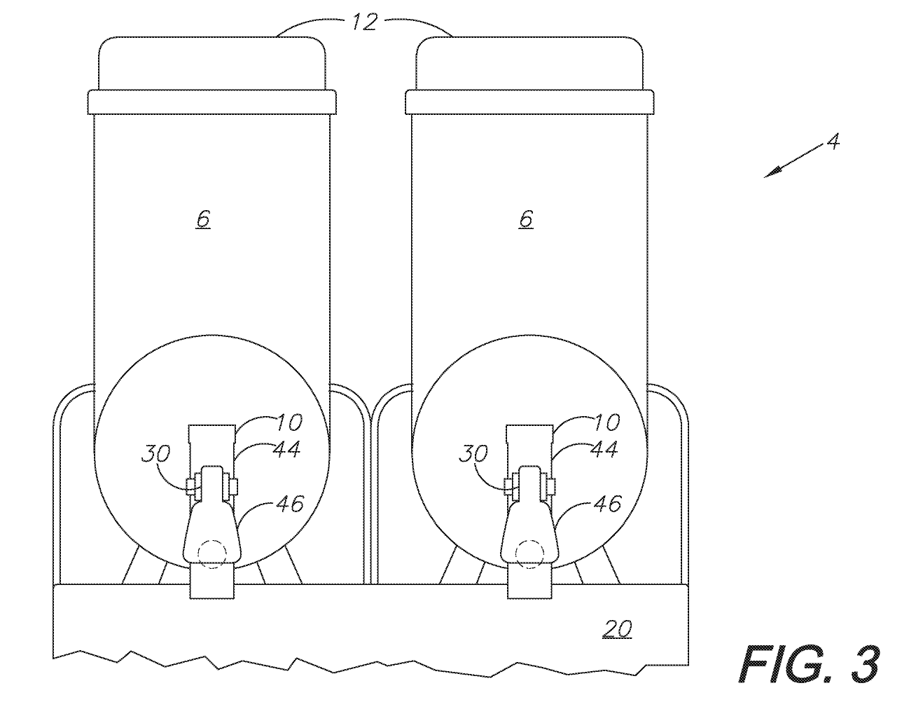

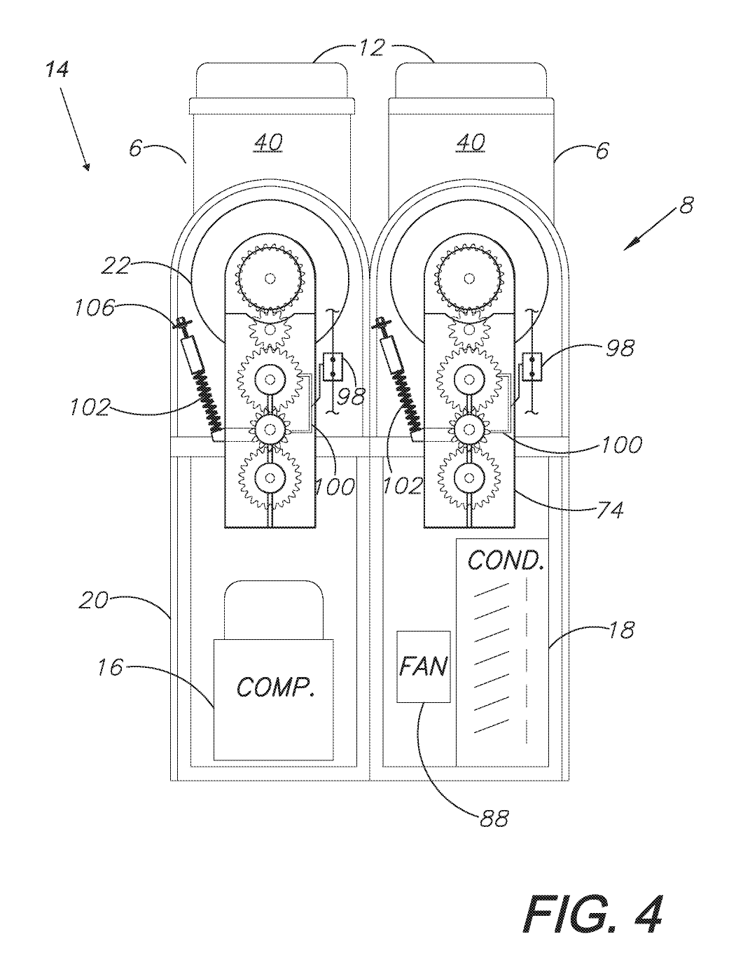

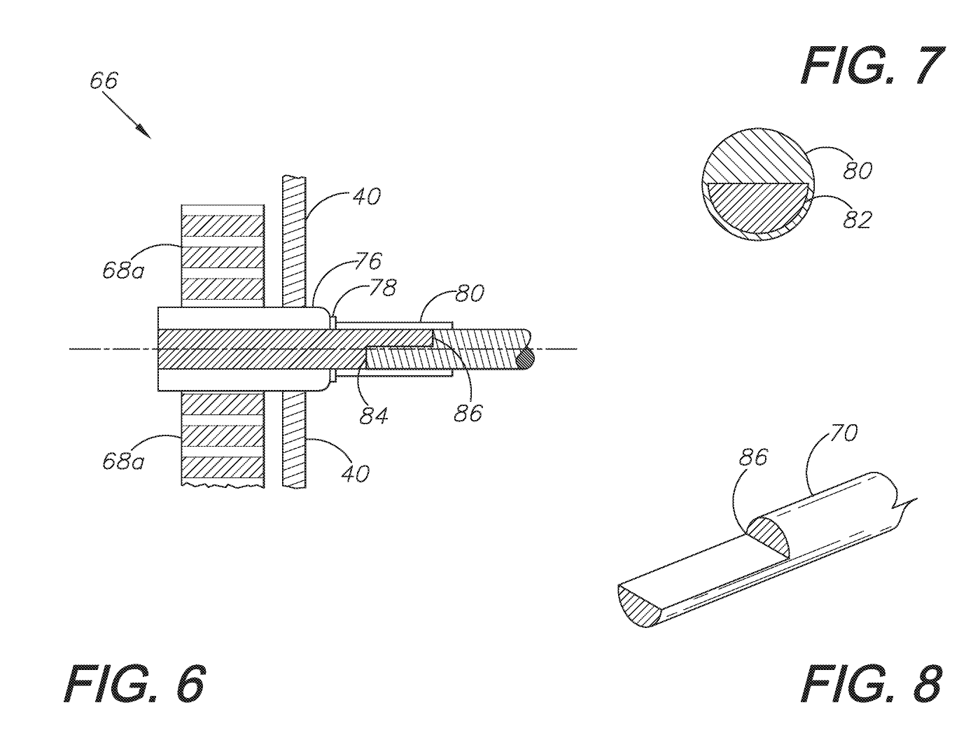

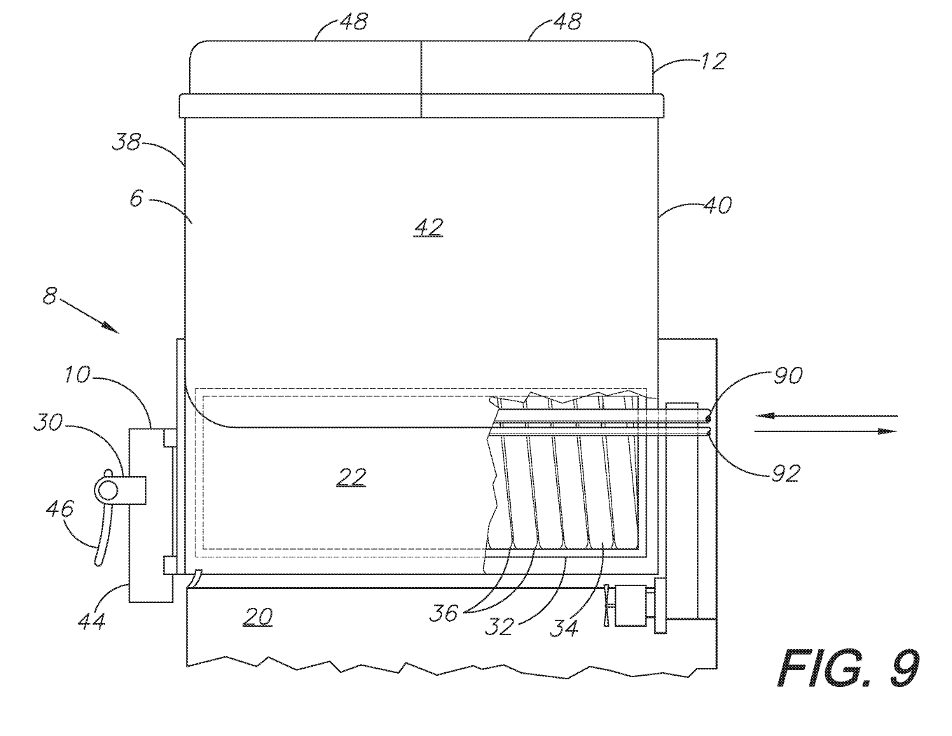

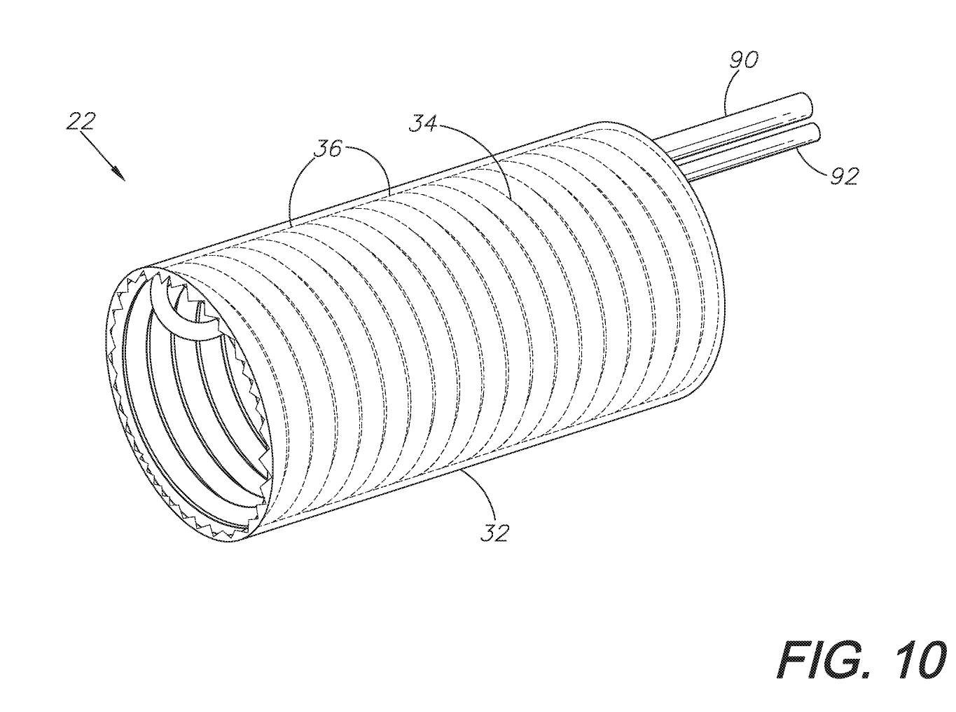

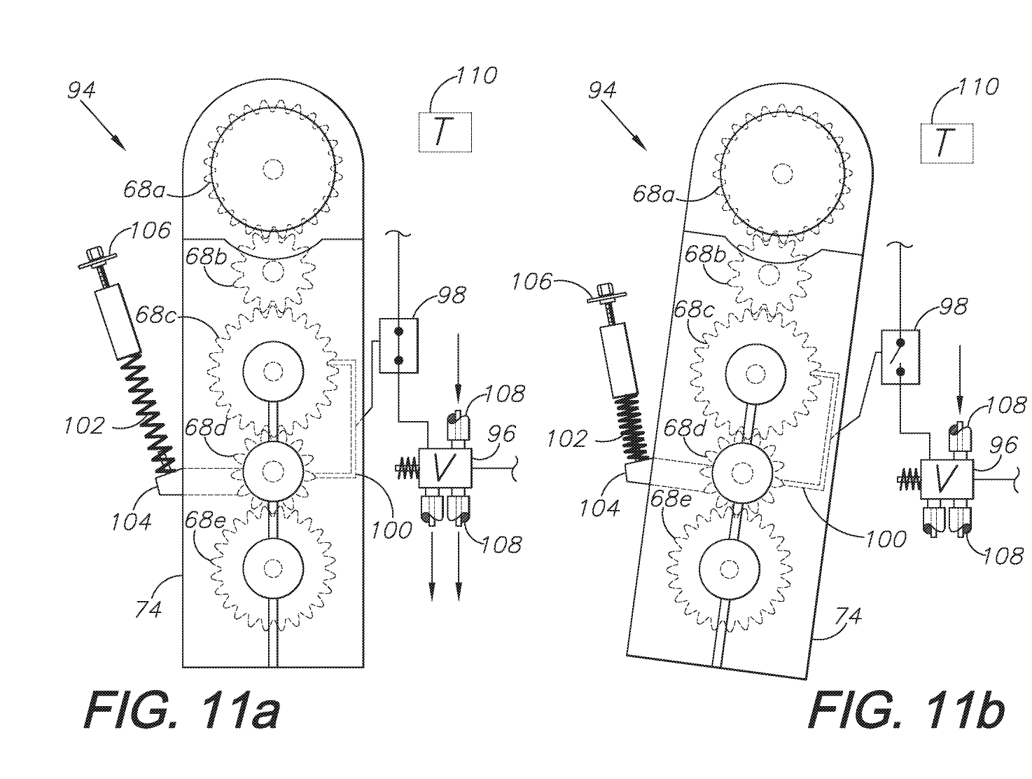

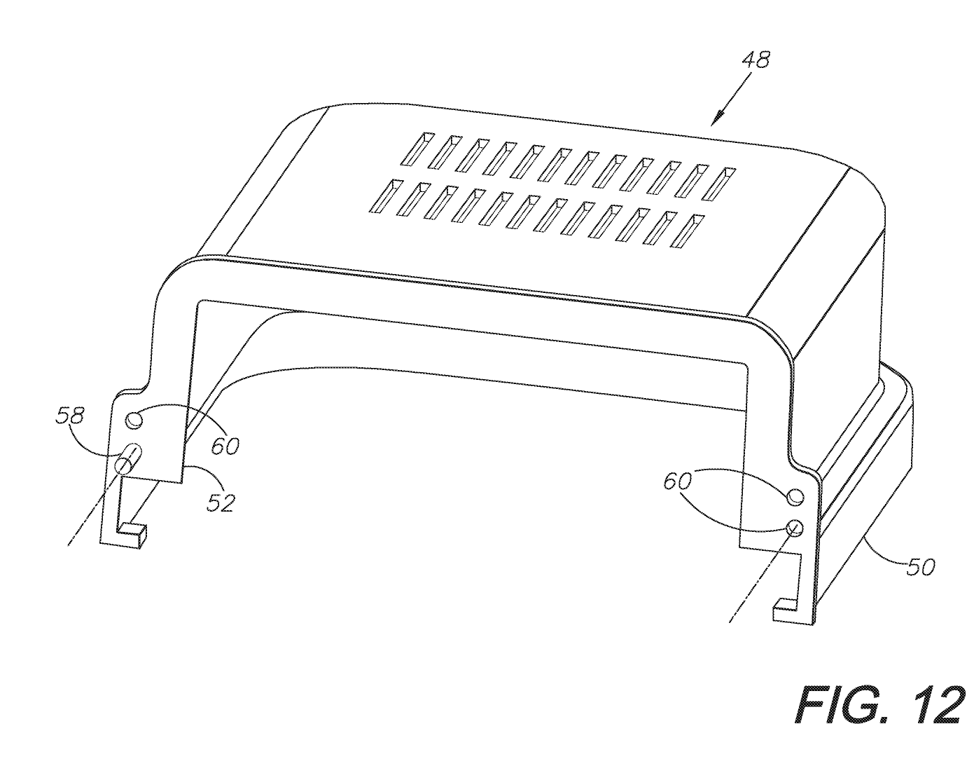

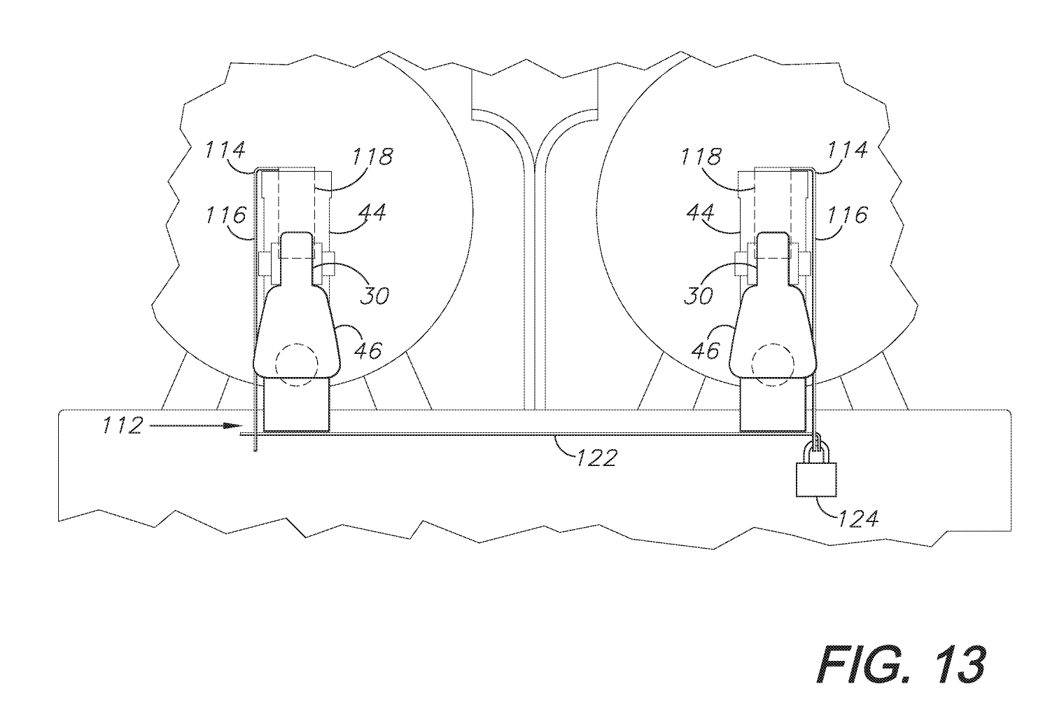

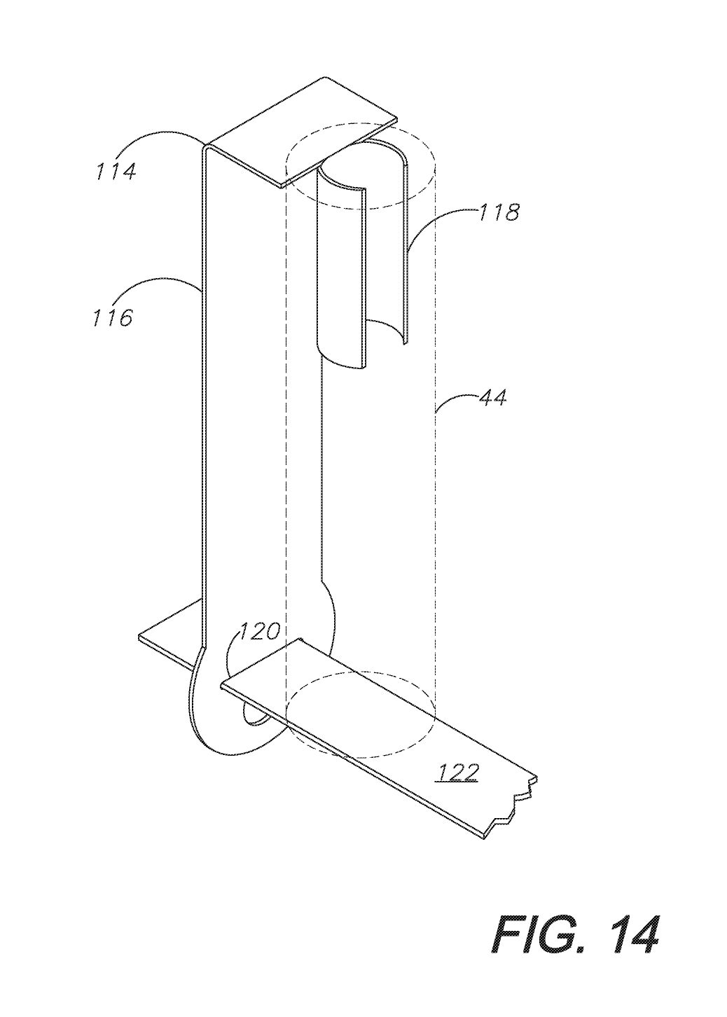

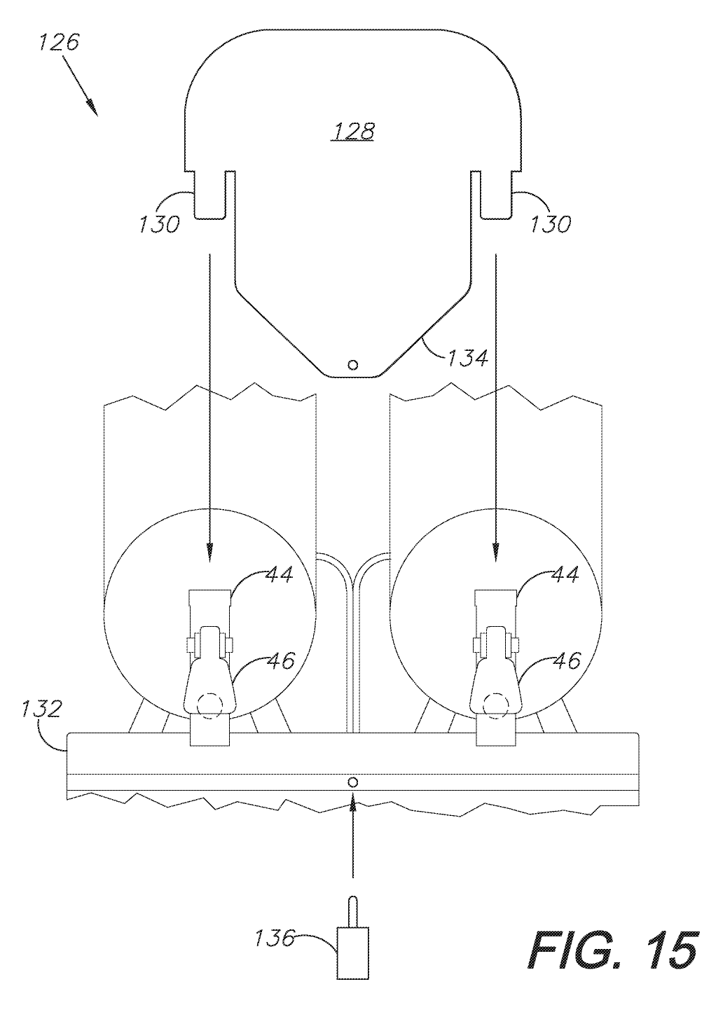

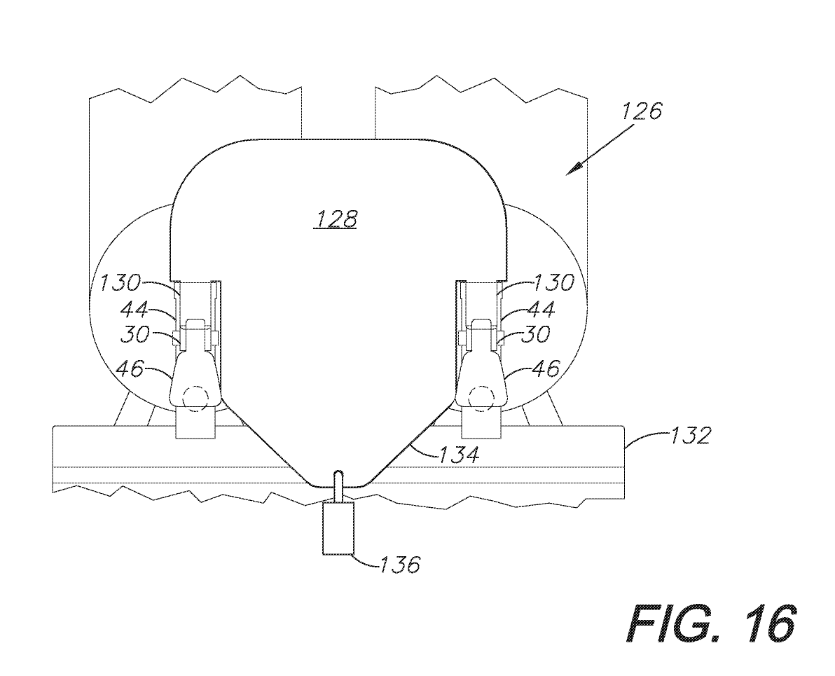

The present invention covers an automated beverage machine 2 for making and dispensing semi-frozen beverages, a method of use, and a method of manufacturing an automated beverage machine 2. In an exemplary embodiment, shown in FIGS. 1-16, the automated, semi-frozen beverage machine 2 of the present invention includes a bowl system 4 having one or more bowls 6, each including a mixing chamber 8, dispensing assembly 10, and a lid assembly 12; a refrigeration system 14 including a compressor 16 and a condenser 18, which are mounted in a base cabinet 20, and an evaporator cylinder 22, located within the bowl mixing chamber 8; and an electrical circuit configured for connection to a power source and for connecting the various components of the beverage machine 2 and user-operated control switches and/or knobs 138.

The mixing chamber 8 includes an auger assembly 24 rotatably mounted around the evaporator cylinder 22, the auger 24 having a helical auger flighting 26, or spiraling grooves, for mixing the content of the mixing chamber 8 and directing the contents toward the dispensing assembly 10. A gear-driven motor assembly 28 is connected to the auger 24 for rotation of the auger 24. The dispensing assembly 10 includes a valve 30, which can be manually opened and closed by a user to dispense contents of the bowl 6. The evaporator cylinder 22 is made up of a hollow metal cylinder 32 with a tight coil of metal tubing 34 within the cylinder 32. The coiled tubing 34 within the cylinder 32 includes flattened outer edges 36 such that the outer edges 36 of the tubing 34 make contact with substantially the entire inner surface area of the metal cylinder 32. The evaporator cylinder 22 receives refrigerant from the compressor 16 and lowers the temperature of the bowl contents to a desired semi-frozen, slush-like consistency for mixing and discharge by the auger 24 and the dispensing valve 30. The lid assembly 12 allows access into the bowl 6 and can mount lights and/or advertisements or informational panels. In a preferred embodiment, the semi-frozen beverage machine 2 further includes an optional locking mechanism 112, 126, 62 on the dispensing assembly 10 and/or the lid assembly 12.

### II. Bowl System

The bowl system 4 of the semi-frozen beverage machine 2 of the present invention includes one or more bowls 6, each including front 38 and back ends 40; opposite sides 42; a mixing chamber 8; a dispensing assembly 10; and a lid assembly 12. In a preferred embodiment, the bowl system 4 is made up of two bowls 6 mounted over a base cabinet 20. Each bowl 6 of the present invention is configured to hold large quantities of a desired semi-frozen beverage. However, beverage machines embodying the present invention can be scaled for size, as desired. The mixing chamber 8 is configured for mixing the contents of the bowl 6 and for directing the bowl contents towards the dispensing assembly 10.

The dispensing assembly 10 is mounted to the front end 38 of the mixing chamber 8 portion of the bowl 6. The dispensing assembly 10 includes a generally vertically-oriented discharge tube 44, selectively communicating with the mixing chamber 8 via a discharge valve 30, which can be manually operated by a user via a valve lever 46. It will be appreciated that various valve structures can be utilized with the automated beverage machine 2 of the present invention. For example, an automated, solenoid-activated valve could be provided and connected to a suitable controller for automating the operation of the machine.

The bowls 6, in this embodiment, are mounted on a base cabinet 20 which houses some of the components of the refrigeration system 14, the electrical circuit, and the adjustment switches and knobs 138. The bowls 6 preferably comprise a clear or transparent plastic material whereby their contents and the operation of the auger system 24 can be readily observed. However, alternatively, the bowls 6 of the beverage machine 2 of the present invention may be translucent, opaque, or non-transparent.

Each lid assembly 12 of the present invention allows access into the bowl 6 for the addition of a desired beverage to the beverage machine 2 or for cleaning. In a preferred embodiment, the lid assembly 12 further houses lights which accommodate backlighting of advertising, promotional, and/or instructional material and information on the outside of the lid assembly 12. Preferably, the lid assembly 12 includes an electrical connection piece for attachment to the electrical circuit housed in the base cabinet 20 of the beverage machine for powering lid assembly 12 lights. In the embodiment shown in FIGS. 1-16, each lid assembly 12 includes a pair of lid halves 48. However, alternatively, each lid assembly 12 can be made up of one lid piece configured for fitting on top of a bowl 6 of the present invention. In this embodiment, each lid half 48 includes a rim 50, which fits over the top of a respective bowl 6; a mating flange 52 at a lid half inner end; and a clear insert slot 54 at a lid half outer end 56 configured for receiving one or more advertising, promotional, and/or instructional material and information panels. Each lid half 48, in this embodiment, mounts an internal light source, which is adapted for backlighting the contents within the clear insert slot 54. Suitable advertising, promotional, and/or instructional material and information can be utilized to promote sales of the semi-frozen beverage. In alternative embodiments, the lid assembly insert slot 54 may be open for internal receipt of advertising, promotional, and/or instructional material and information panels, rather than having a clear outer covering for such panels. In this embodiment, the lid halves 48 include respective pins 58, which project from respective flanges 52 and are received in pin receivers 60, which are formed in the lid half flanges 52 in opposing relation to the pins 58. The flanges 52 include additional receivers 60, which can receive padlocks 62 so that the contents of the bowls 6 can be secured and access thereto restricted to only authorized personnel. Preferably the semi-frozen beverage machine 2 of the present invention includes user-operable switches 138 on the outside of the base cabinet 20 for turning on and off the lid assembly lights.

### III. Mixing Chamber

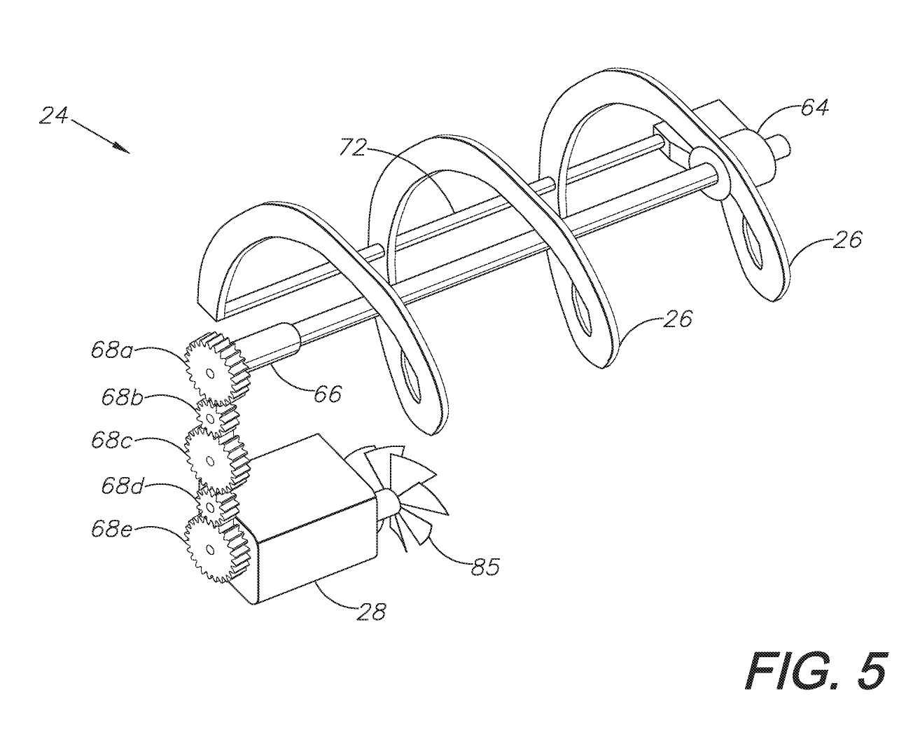

The mixing chamber 8 of the present invention includes an auger assembly 24 located in the lower portion of each bowl 6, placed around an evaporator cylinder 22, and a gear-driven motor 28 connected to the electrical circuit. The auger assembly 24 extends from the front 38 to the back 40 of the lower portion of the bowl 6, having front 64 and back bearings 66 connected to the bowl front 38 and back ends 40 and coaxial gears 68a,b,c,d,e drivingly connected to the back bearing 66 and to the gear-driven motor 28. A drive shaft 70 extends between the front 64 and back bearings 66 and is connected to a helical auger flighting 26, which mounts a sweep bar 72 positioned in parallel, spaced relation to the drive shaft 70 and the gears 68a,b,c,d,e. The gear-driven motor assembly 28 includes a motor drivingly connected to a lower gear 68e via a suitable gearbox 74, which drives a series of gears 68a,b,c,d,e which rotate the auger assembly 24. FIG. 5 shows five gears 68a,b,c,d,e for rotating the auger 24, without the associated gearbox housing 74 for illustration, however, an alternative number of gears may be used.

In further embodiments, the auger assembly 24 may include a drive belt assembly for rotating the auger 24 rather than gears. In such an embodiment, the drive belt assembly includes a toothed drive belt, which connects to the back bearing 66, which is connected to the drive shaft 70 of the auger 24. The toothed belt, in such an embodiment, rotates the auger drive shaft 70 via an upper and lower gear of the gear-driven motor 28. Further alternative auger driving mechanisms may be used rather than gears or a drive belt in beverage machines 2 embodying the present invention.

The auger back bearing 66 may include a bushing 76 which extends through the bowl back end 40, connects to an upper gear 68a, and receives the drive shaft 70 having a collar 78 engaging the bushing 76 and an inner coupling 80. Such a drive shaft coupling 80 includes a receiver 82 with a semicircular cross-sectional configuration and a step 84, which corresponds to the configuration of the back end of the drive axle 70, including a step 86. In some embodiments, an end cap may be placed on the end of the drive shaft 70 for extending into the drive shaft receiver 82. Moreover, optionally, a cotter pin may be used extending through the upper gear 68a, the end cap (if included), and the drive axle 70 to hold them in position.

The drive shaft 70 of the auger system 24 extends lengthwise through the center of the evaporator cylinder 22 in the lower portion of the mixing chamber 8 in the bowl 6, such that in use, the auger 24 rotates around the evaporator cylinder 22, with the auger 24 rotating and the evaporator cylinder 22 remaining stationary. The sweep bar 72 and helical flighting 26 design of the auger assembly 24 are configured for mixing the beverage contents of the bowl 6 and for directing the beverage contents toward the dispensing assembly 10 at the lower portion of the front side 38 of the bowl 6. Turning of the auger 24 circulates the contents of the bowl 6 so that the beverage contents make repeated contact with the evaporation cylinder 22, cooling and maintaining the beverage at a desired semi-frozen consistency.

The gear-driven motor 28 mounts a cooling fan 85 and can be provided with suitable overload protection for preventing damage to the gear assembly 68a,b,c,d,e. Preferably, a back cover is placed over the back of the machine 2 and covers the gear assemblies 86a,b,c,d,e and other components of the machine 2, which can be accessed by removing the back cover.

### IV. Refrigeration System

In this embodiment, the refrigeration system 14 includes a compressor 16 and condenser coils 18 mounted within the base cabinet 20; an evaporator cylinder 22 mounted within the mixing chamber 8 portion of the bowl 6; a fluid pump; and a fan 88 is directed to the condenser coils 18. The refrigeration system 14 is filled with a refrigerant, such as but not limited to Freon. In a preferred embodiment, the compressor 16 is a rotary compressor, however alternative types of compressors can be used. Additionally, the number of condenser coils 18 can be scaled, as desired, within the base cabinet 20 for efficiency.

The evaporator cylinder 22 is made up of an outer, hollow, cylindrical, metal tube 32 and an inner, coaxial, tightly coiled, metal tubing 34. The coil 34 of the evaporation cylinder 22, in this embodiment, includes expanded, flattened outer edges 36 such that the outer edges 36 of the coiled tubing 34 flatten up against the inner surface of the metal cylinder 32, covering substantially the entire inner surface area of the cylinder 32. Such a configuration of coiled tubing 34 provides additional surface contact between the coiled tubing 34 and outer cylinder 32 of the evaporator cylinder 22, resulting in improved heat transfer and ultimately quicker cooling of the beverage contents of the bowl 6 to a desired semi-frozen consistency. In a preferred embodiment, the evaporation cylinder 22 outer metal tube 32 is made up of stainless steel, and the inner coil 34 is made up of copper tubing. However, in alternative embodiments, other metals may be used.

Each evaporator cylinder 22 coiled tubing 34 includes an inlet port 90 and an outlet port 92 for receiving and discharging refrigerant to and from the condenser coils 18. In a preferred embodiment, the evaporator coil inlet 90 and outlet ports 92 are each located near the back side of evaporator cylinder 22, however alternative inlet/outlet configurations can be utilized in beverage machines 2 of the present invention. In an exemplary embodiment, the inlet 90 and outlet ports 92 and connection conduit tubing to the condenser coils 18 are wrapped in insulating material, such as insulating foam, to improve the efficiency of desired heat transfer.

In use, refrigerant is pumped into the evaporator coil 34 of the evaporator cylinder 22. The evaporator cylinder 22 absorbs heat from the bowl contents, and the liquid refrigerant within the evaporation coil 32 converts into gas. Refrigerant in a gaseous state is discharged from the evaporator cylinder 22 into the condenser coils 18. The compressor 16 applies pressure to the refrigerant, returning the refrigerant to a liquid state, while the exhaust fan 88 blows air onto the condenser coils 18 towards an opening in the base cabinet 20, releasing heat from the beverage machine 2. The liquid refrigerant is pumped back into the evaporator cylinder 22, and the process resets. Preferably, a user-operated switch 138 on the outside of the base cabinet 20 turns on and off the refrigeration system 14 of the beverage machine 2.

A product consistency control mechanism 94 includes a solenoid-activated refrigerant valve 96 interposed between the compressor 16 and the evaporator cylinder inlet port 90. The valve 96 is activated by a microswitch 98, which is located adjacent to a boss 100 attached to the auger gearbox assembly 74. The gearbox 74 of the auger assembly 24 is configured for swinging through a limited range of rotational movement, whereby the boss 100 closes the microswitch 98, and refrigerant flows into the evaporator cylinder 22 in normal operation. When product in the mixing chamber 8 becomes too cold and freezes beyond a desired semi-frozen consistency, the beverage contents exert a torque backforce on the auger 24, causing the gearbox 74 to swing clockwise and open the microswitch 98. When the microswitch 98 opens, the solenoid valve 96 closes, blocking the flow of refrigerant to the evaporator cylinder 22. The product gradually thaws to its desired semi-frozen consistency, whereupon the torque backforce on the gearbox 74 reduces until an auger assembly return spring 102 overcomes the backforce and swings the gearbox 74 counterclockwise to a refrigerating position, closing the microswitch 98 and repeating the cycle. In other embodiments of the present invention, the direction of the auger 24 and swinging of the gearbox 74 may be reversed.

The auger assembly return spring 102 is compressed between a spring boss 104 and a threadably-adjustable spring compression mechanism 106. The compression mechanism 106 enables an operator to adjust the consistency of the product, as desired, by pre-compressing the return spring 102 using an adjustment knob. Greater compression increases the coldness and hardness of the semi-frozen product and vice versa. Conduits 108 are provided for distributing refrigerant among the components of the refrigeration system 14 and can be insulated as necessary. The refrigeration system 14 of the present invention accommodates very quick and efficient cooling of beverages.

As an alternative to the consistency mechanism 94, the refrigeration system 14 can be controlled based on the temperature of the product in the bowls 6. For example, thermostats 110 can be used in lieu of the microswitches 98 for controlling the refrigerant valves 96 in response to product temperature, which can be sensed directly or indirectly, such as with infrared temperature sensing equipment.

### V. Method of Manufacturing Evaporation Cylinder of Refrigeration System

To manufacture an evaporation cylinder 22 for a semi-frozen beverage machine 2 of the present invention, metal tubing 34 is first wound in a tight coil into a hollow, metal cylinder or canister 32. In a preferred embodiment, the coiled metal tubing 34 is made up of copper tubing, and the hollow, metal cylinder 32 is made up of stainless steel. Alternatively, other metals may be used, as long as the yield strength of the coiled tubing metal is less than the yield strength of the outer cylinder metal. Yield strength, also known as yield point or yield stress, is the stress point at which a material begins to deform plastically, resulting in non-reversible changes of shape.

In an exemplary embodiment, the copper tubing 34 is coiled into the steel cylinder 32 using a shop lathe having a cylindrical or rod-shaped mandrel. However, the copper tubing 34 may be coiled into the steel cylinder 32 using other types of coiling tools. In this embodiment, copper tube 34 is fed through a roll fixture, and a leg bend is formed in the tubing 34 a desired length from the end of the copper tube 34, forming an approximately 90-degree bend in the copper tubing 34. The tube end may then be butterflied.

Using a lathe with a cylindrical or rod-shaped mandrel, the bent leg portion of the copper tubing 34 is inserted within a notch on the lathe, and a desired coil thread indicator and thread feed are set and engaged on the mandrel. The copper tube 34 is clamped into the roll mandrel, and flattening rolls are clamped together. The copper coil 34 is then rolled to a predetermined coil point. In a preferred embodiment, a compound cross feed is used to adjust the coil winding for a tight coil. The flattening rolls are then opened, and the copper tube 34 is coiled further until the bent portion of the tube comes tangent to the roll mandrel. At this point, the copper coil 34 is fully coiled or wound, and the copper tube 34 is cut using a tube cutter at the support end.

The copper coil 34 can then been removed from the lathe and roll fixture, carefully releasing the tension on the coil 34 until the coil is neutral. A cap tube is then cut and wound as desired. The cap coil is aligned with a butterfly crimper tool and crimped tight so that silver solder fills the joint, the cap tube being supported during the silver solder operation to prevent it from moving around.

Once the silver solder joint is formed, a leak test is performed on the silver solder joint. In a preferred embodiment, an end of the coil 34 is plugged, and a needle is used to charge the coil 34. In an exemplary embodiment, with the cap tube end plugged, soapy water is applied to the silver solder braze joint. The coil 34 is then charged with dry air (100 psig in a preferred embodiment, but alternative pressures can be used) while the outside of the solder joint is examined for soap bubbles. Alternatively, other methods for testing for leaks may be utilized. If there are no leaks in the solder joint, the copper coil 34 fabrication process is complete. After fabrication, it is important that the copper coil 34 is carefully handled so the cap tube does not break off at the solder joint.

The copper coil 34 is then ready for application of thermal mastic and for insertion into a stainless steel tube canister 32. Thermal mastic—sometimes colloquially referred to as “peanut butter” in the industry because of its peanut butter-like consistency—is a masking product configured for efficiently transferring BTU's for cooling. Prior to insertion of the copper coil 34 into the canister 32, the canister mouth is examined for any rough welds. If there are rough welds present, each rough weld is ground smooth. Once the welds are ground smooth, the inside of the canister well is cleaned. Thermal mastic is then applied to the outside of the copper coil 34, coating the outside of the coil 34. The coated copper coil 34 is inserted into the canister 32 by hand. In a preferred embodiment, the coil 34 is slightly rotated clockwise as it is pushed into the canister 32 to ease the insertion process. Optionally, a wooden disc can be used to bottom out the coil 34 in the canister 32. Once the copper coil 34 is inserted into the canister 32, any excess mastic is cleaned off from the canister mouth.

Once the copper coil 34 is assembled within the steel cylinder canister 32, the cylinder 32 is placed within a hydro expansion chamber. Within the hydro chamber, the copper coil 34 is filled with water and plugged off. The hydro chamber is then pressurized to a desired high pressure setting. In a preferred embodiment, the high pressure setting is higher than the yield strength of copper but lower than the yield strength of stainless steel. In an exemplary embodiment, the hydro chamber is pressurized within a range of 2,500 to 2,900 pounds per square inch gauge (psig) during the hydro expansion process of the evaporation cylinder copper coil 34, however alternative pressures may be used which are above the yield strength of copper and below the yield strength of stainless steel. In an exemplary embodiment, the chamber is pressurized to 2,600 psig. Other pressures may be used in alternative embodiments utilizing different materials based on the yield strengths of those materials. This hydro expansion process, utilizing these pressure levels, causes the copper coil 34 to expand, pushing its outer edges 36 flat up against the interior surface of the steel cylinder canister 32 such that the edges 36 of the copper coil 34 substantially cover the entire interior surface area of the canister 32. This accommodates more efficient heat transfer during the cooling process. After pressurization and expansion is complete, the pressure is relieved from the hydro chamber, and the copper coil 34 is drained. Any excess water is blown out with air, and the cylinder 22 is removed from the chamber.

The assembled evaporator cylinder 22 is then placed within an oven to allow the parts to heat and dry out. In an exemplary embodiment, an oven is set to approximately 140 degrees Fahrenheit, and the cylinder 22 is placed within the oven for one hour. However, alternative oven temperature settings and/or drying times may be used. Other drying techniques may also be used. The cylinder 22 is then removed from the oven and allowed to cool down.

Once the parts have cooled, the coil tube 34 end is crimped using a butterfly crimper tool by inserting a cap tube into the butterfly crimper and pinching tight. A zip tie can be used to hold and support the cap tube during the silver soldering process. The cylinder 22 is laid on its side, a heat shield is inserted, and the cap tube is flux and brazed. The joint is tested for leaks, and if there are no leaks, the fabrication is complete. The coiled tubing inlet 90 and outlet tubes 92 are capped, and the evaporation cylinder 22 is complete and ready for installation into a semi-frozen beverage machine 2 of the present invention.

### VI. Locking Systems

Optionally, a dual-plate locking system 112 can be used to lock the beverage machine 2 of the present invention. The dual-plate locking system 112 includes a pair of dispenser retainers 114 each having a plate 116 adapted for placement alongside a respective dispensing tube 44. Further, each plate 116 has an insert 118 adapted for insertion into a respective dispensing tube 44 such that the dispensing valve 30 is retained in a closed position. Each plate 116 also has a slot 120 at its lower end. With the retainers 114 in place, the slots 120 are located immediately below the lower ends of the dispensing tubes 44 accommodating a bar 122 being slid through the slots 120 and secured to one of the plates 116 by a suitable padlock 124. In the locked configuration, the dispensing valve levers 46 cannot be raised, and the contents of the machine 2 are secured. Similar retainers can be provided for individually securing single-bowl machines or either of the bowls 6 of the machine 2 shown.

Alternatively, a single-plate locking system 126 can be used. Such a single-plate locking system 126 includes a plate 128 with a pair of inserts or fingers 130, which extend into the dispensing tubes 44 in a locked configuration. A receiver plate 132 receives an angle-section member 134 of the plate 128 lower end and is attached thereto by a padlock 136. The angle-section member receiver 132 engages the lower ends of the dispensing tubes 44 in the locked position, thus securing the contents of the bowls 6.

It is to be understood that the invention can be embodied in various forms and is not to be limited to the examples specifically discussed above. The range of components and configurations which can be utilized in the practice of the present invention is virtually unlimited.

Having thus described the invention, what is claimed as new and desired to be secured by Letters Patent is:

1. A method of producing an evaporator cylinder for an automated semi-frozen beverage machine comprising the steps of:
providing a hollow metal cylinder made up of a first metal and having first and second ends, a longitudinal axis extending between said first and second ends, and inner and outer surfaces;
providing a metal tubing made up of a second metal;
wherein said second metal has a lower yield strength than said first metal;
coiling said metal tubing within said metal cylinder, coaxial with said metal cylinder to a length approximately equal to the length of said metal cylinder;
wherein said coiled metal tubing includes an inlet port and an outlet port;
sealing said coiled metal tubing outlet port;
filling said coiled metal tubing with water through said coiled metal tubing inlet port;
pressurizing said water within said coiled metal tubing to a pressure above the yield point of said second metal and below the yield point of said first metal;
said coiled metal tubing expanding under said pressure, resulting in outer edges of said coiled metal tubing flattening against said metal cylinder inner surface such that said coiled metal tubing outer edges make contact with approximately all of said metal cylinder inner surface;
removing pressure from said evaporator cylinder;
draining said water from said coiled metal tubing; and
opening said coiled metal tubing outlet port.

2. The method according to claim 1, wherein:
said first metal comprises stainless steel; and
said second metal comprises copper.

3. The method according to claim 2, wherein:
said pressure comprises pressure in the range of 2,500 pounds per square inch gauge (psig) to 2,900 psig.

4. The method according to claim 1, further comprising the step of:
applying thermal mastic to said coiled metal tubing.

5. The method according to claim 1, further comprising the step of:
heating said evaporation cylinder to dry out any remaining water.

6. The method according to claim 1, wherein:
said sealing said coiled metal tubing outlet port comprises crimping said coiled metal tubing outlet port; and
said opening said coiled metal tubing outlet port comprises cutting said coiled metal tubing outlet port upstream of said crimping.

7. The method according to claim 1, further comprising the step of:
inserting said evaporator cylinder into a refrigeration system of an automated semi-frozen beverage machine.

8. An automated semi-frozen beverage machine comprising:
a bowl system including a bowl having a mixing chamber, a dispensing assembly, and a lid assembly;
wherein said bowl includes front and back ends, opposite sides, and an open top;
wherein said bowl is configured for receiving and holding a quantity of a desired beverage;
a refrigeration system including a compressor, a condenser, and an evaporator cylinder;
said evaporator cylinder being positioned within a lower portion of said bowl extending between said bowl front and back ends;
said evaporator cylinder comprising an outer hollow metal cylinder having inner and outer surfaces and an inner coiled metal tubing having a flattened outer edge such that said coiled metal tubing outer edge makes contact with approximately all of said metal cylinder inner surface;
said coiled metal tubing having an inlet port configured for receiving refrigerant from said compressor and an outlet port configured for discharging refrigerant to said condenser;
wherein said evaporator cylinder is configured for absorbing heat from said beverage;
said mixing chamber including an auger assembly positioned within said lower portion of said bowl extending between said bowl front and back ends around and coaxial with said evaporator cylinder;
said auger assembly comprising a helical flighting and a drive assembly configured for rotating said helical flighting around said evaporator cylinder for mixing said beverage within said bowl and directing said beverage toward said dispensing assembly;
said dispensing assembly including a dispensing tube communicating with a lower, front portion of said bowl and a dispensing valve having an open position opening said dispensing tube and a closed position closing said dispensing tube;
said lid assembly configured for mating with and closing said bowl open top; and
a base cabinet positioned beneath said bowl system and housing said refrigeration system compressor and condenser.

9. The automated semi-frozen beverage machine according to claim 8, further comprising:
a backforce resistance assembly connected to said drive assembly and activated in response to a viscosity of said beverage causing a torque backforce on said auger assembly;
said backforce resistance assembly comprising said drive assembly being rotatably mounted with respect to said bowl system, said backforce resistance assembly being deflectable from a first position to a second position with respect to a vertical axis of said auger assembly and configured for rotating between said first and second positions in response to said torque backforce;
said torque resistance assembly including a switch in contact with said drive assembly and having open and closed positions corresponding to said drive assembly first and second positions respectively;
a refrigerant line extending from said compressor to said evaporator cylinder coiled metal tubing; and
a solenoid valve in said refrigerant line, said solenoid valve having an open position corresponding to said switch closed position and a closed position corresponding to said switch open position.

10. The automated semi-frozen beverage machine according to claim 8, wherein:
said metal cylinder is made up of stainless steel.

11. The automated semi-frozen beverage machine according to claim 8, wherein:
said coiled metal tubing is made up of copper.

12. The automated semi-frozen beverage machine according to claim 8, wherein:
said driving assembly comprises a gear-driven motor and a series of gears drivingly connected to said helical flighting.

13. The automated semi-frozen beverage machine according to claim 12, wherein:
said series of gears and said helical flighting are connected to a drive shaft extending through the center axis of said helical flighting and through the center of said evaporator cylinder for rotating said helical flighting around said evaporator cylinder.

14. The automated semi-frozen beverage machine according to claim 8, wherein:
said helical flighting further comprises a sweep bar configured for mixing said beverage.

15. The automated semi-frozen beverage machine according to claim 8, wherein:
said bowl system comprises two bowls each having a mixing chamber, a dispensing assembly, and a lid assembly.

16. The automated semi-frozen beverage machine according to claim 8, further comprising:
a locking mechanism configured for locking said dispensing valve in said closed position.

17. The automated semi-frozen beverage machine according to claim 8, wherein:
said lid assembly further comprises lights for illuminating said lid assembly.

18. The automated semi-frozen beverage machine according to claim 8, further comprising:
a thermostat configured for detecting the temperature of said beverage within said bowl;
a refrigerant line extending from said compressor to said evaporator cylinder coiled metal tubing; and
a solenoid valve in said refrigerant line and operably connected to said thermostat, said solenoid valve having open and closed positions corresponding to said temperature of said beverage within said bowl.

19. The automated semi-frozen beverage machine according to claim 8, wherein:
said refrigeration system further comprises an exhaust fan configured for blowing air towards said condenser and releasing heat from said beverage machine.

20. A method of making an semi-frozen beverage machine using a semi-frozen beverage machine including a bowl system including a bowl having a mixing chamber, a dispensing assembly, and a lid assembly; the bowl having front and back ends, opposite sides, and an open top; a refrigeration system including a compressor, a condenser, and an evaporator cylinder; the evaporator cylinder being positioned within a lower portion of the bowl extending between the bowl front and back ends; the evaporator cylinder including an outer hollow metal cylinder having inner and outer surfaces and an inner coiled metal tubing having a flattened outer edge such that the coiled metal tubing outer edge makes contact with approximately all of the metal cylinder inner surface; the coiled metal tubing having an inlet port and an outlet port; the mixing chamber including an auger assembly positioned within the lower portion of the bowl extending between the bowl front and back ends around and coaxial with the evaporator cylinder; the auger assembly including a helical flighting and a drive assembly configured for rotating the helical flighting around the evaporator cylinder; the dispensing assembly including a dispensing tube communicating with a lower, front portion of the bowl and a dispensing valve having an open position opening the dispensing tube and a closed position closing the dispensing tube; and the lid assembly configured for mating with and closing said bowl open top, the method comprising the steps of:
pouring a desired semi-frozen beverage in liquid form into said bowl through said bowl open top;
closing said bowl open top with said lid assembly;
said compressor pumping refrigerant into said evaporator cylinder coiled metal tubing through said inlet port;
said evaporator cylinder absorbing heat from said beverage and cooling said beverage to a desired semi-frozen consistency;
said evaporator cylinder coiled metal tubing discharging refrigerant to said condenser through said outlet port;
said auger assembly mixing said beverage within said bowl and directing said beverage toward said dispensing assembly; and
a user dispensing said beverage from said dispensing tube via said dispensing valve.
